(19) United States
(12) Patent Application Publication
(10) Pub. No.: US 2017/0193013 A1
(43) Pub. Date: Jul. 6, 2017

(54) DATA STORAGE SPACE CONFIGURATION OF A HARD DISK DRIVE AND METHOD OF CONFIGURING DATA STORAGE SPACE OF A HARD DRIVE TO LIMIT SEEK DISTANCES DURING DATABASE METADATA UPDATES

(71) Applicant: Teradata US, Inc., Dayton, OH (US)

(72) Inventor: Matthew James Fischer, Escondido, CA (US)

(73) Assignee: Teradata US, Inc., Dayton, OH (US)

(21) Appl. No.: 15/098,642

(22) Filed: Apr. 14, 2016

Related U.S. Application Data
(60) Provisional application No. 62/273,812, filed on Dec. 31, 2015.

(51) Int. Cl. G06F 17/30; G11B 20/12

(52) U.S. Cl. CPC G06F 17/30292; G11B 20/1217; G06F 17/30312; G11B 2020/1241; G11B 2020/1242

(57) ABSTRACT

A data storage space configuration of a hard disk drive comprises a plurality of zones in which each one of the plurality of zones stores customer data. The data storage space configuration further comprises a plurality of database metadata storage spaces allocated in the plurality of zones, wherein the number of database metadata storage spaces is less than or equal to the number of zones. The database metadata may comprise temporary metadata. The database metadata may comprise write-ahead log (WAL) metadata. The database metadata may comprise staged-write (DEPOT) metadata for the purpose of interrupted write recovery.

### CROSS REFERENCE TO RELATED APPLICATIONS

This application claims priority under 35 U.S.C. §119(e) to the following co-pending and commonly-assigned patent application, which is incorporated herein by reference:

Provisional Patent Application Ser. No. 62/273,812, entitled “DATA STORAGE SPACE CONFIGURATION OF A HARD DISK DRIVE AND METHOD OF CONFIGURING DATA STORAGE SPACE OF A HARD DRIVE TO LIMIT SEEK DISTANCES DURING DATABASE METADATA UPDATES,” filed on Dec. 31, 2015, by Matthew James Fischer.

### TECHNICAL FIELD

The present disclosure relates to hard disk drives, and is particularly directed to a data storage space configuration of a hard disk drive and a method of configuring data storage space of a hard disk drive to limit seek distances during database metadata updates.

### BACKGROUND

As a database system matures and available customer data storage capacity of a hard disk drive (HDD) is consumed, seek distances become larger during database metadata updates. This occurs in part due to physically-distant separation between database metadata storage space and customer data storage space. Certain metadata in some known database systems occupy a single contiguous region of a HDD. As the data storage capacity of the database system fills up, the seek distance the head of the HDD must travel to complete certain database update operations grows significantly. The increased seek distances not only increase mechanical wear on components of the HDD, but also impact performance of the database system due to longer seek times.

The effect of larger seek distances, and therefore larger seek times, is most acutely felt when the database metadata resides on the outer diameter of the HDD platter where transfer rates are highest. Placing database metadata on this “fast region” (outer diameter of the HDD platter) of the HDD is advantageous on immature systems since customer data is adjacent to the database metadata. As the database matures and additional customer data is loaded to the system, customer data will extend to the “medium region” (middle diameter of the HDD platter) and “slow region” (inner diameter of the HDD platter), where transfer rates are lower. This creates a situation where large seeks can occur during concurrent access of database metadata and customer data, which impacts overall system performance. This effect can be mitigated to some extent by moving the database metadata from the outer diameter of the HDD further into the middle diameter of the HDD (which reduces the maximum seek time by one-half and is often referred to as a “half seek”), but this often results in one of two problems.

One problem is that suboptimal scan performance can occur if the database system allocates its cylinders and extents (for customer data) from the middle diameter of the HDD to the outer diameter of the HDD. Suboptimal scan performance would result because the order of allocation by the database system would be “reversed” relative to progression of logical block addresses on the HDD. Alternatively, if the database system allocates its cylinders and extents (for customer data) from the outer diameter of the HDD to the inner diameter of the HDD, this results in the second problem: “half seeks” between customer data (at the outer diameter) and database metadata (at the middle diameter) on immature database systems that would otherwise have both database metadata and customer data in the “fast region” (i.e., the outer diameter) of the HDD.

It would be desirable to provide a data storage space configuration of a HDD and a method of configuring data storage space of a HDD to limit seek distances during database metadata updates, and to have resulting benefits apply to both immature (lightly filled) and mature (mostly full) databases.

### SUMMARY

In accordance with an embodiment, a data storage space configuration of a hard disk drive comprises a plurality of zones in which each one of the plurality of zones stores customer data. The data storage space configuration further comprises a plurality of database metadata storage spaces allocated in the plurality of zones, wherein the number of database metadata storage spaces is less than or equal to the number of zones. The database metadata may comprise temporary metadata. The database metadata may comprise write-ahead log (WAL) metadata. The database metadata may comprise staged-write (DEPOT) metadata for the purpose of interrupted write recovery.

In accordance with another embodiment, a method of configuring data storage space of a hard disk drive is provided. The method comprises electronically by a processor, defining a plurality of zones on the hard disk drive, electronically by a processor, storing customer data in each one of the plurality of zones, and electronically by a processor, allocating a plurality of database metadata storage spaces in the plurality of zones, wherein the number of metadata storage spaces is less than or equal to the number of zones. The database metadata may comprise temporary metadata. The database metadata may comprise write-ahead log (WAL) metadata. The database metadata may comprise staged-write (DEPOT) metadata for the purpose of interrupted write recovery. The method may be performed by a computer having a memory executing one or more programs of instructions which are tangibly embodied in a program storage medium readable by the computer.

In accordance with still another embodiment, a method of collocating customer data and database metadata on a hard disk drive is provided. The method comprises dividing data storage space of the hard disk drive into a plurality of zones, allocating a portion of the data storage space within each zone of the plurality of zone for storing customer data, and allocating a portion of the data storage space within a plurality of the plurality of zones for storing database metadata. The number of the plurality of the plurality of zones for storing database metadata may be less than the number of the plurality of zones. The number of the plurality of the plurality of zones for storing database metadata may be equal to the number of the plurality of zones. The database metadata may comprise temporary metadata. The database metadata may comprise write-ahead log (WAL) metadata. The database metadata may comprise staged-write (DEPOT) metadata for the purpose of interrupted write recovery. The method may be performed by a computer having a memory executing one or more programs of instructions which are tangibly embodied in a program storage medium readable by the computer.

### BRIEF DESCRIPTION OF THE DRAWINGS

Aspects of the present disclosure are best understood from the following detailed description when read with the accompanying figures, in which

FIG. 1 depicts a diagrammatic representation of a prior art data storage space configuration of a hard disk drive (HDD) allocating customer data and database metadata.

FIG. 2 depicts a diagrammatic representation of a data storage space configuration of a HDD allocating customer data and database metadata in accordance with an embodiment.

FIG. 3 is a flowchart that depicts processing of an example routine to facilitate configuring data storage space of a HDD to limit seek distances during database metadata updates in accordance with disclosed embodiments.

FIG. 4 shows an example computer system capable of operating in accordance with an embodiment.

### DETAILED DESCRIPTION

It is to be understood that the following disclosure provides many different embodiments or examples for implementing different features of various embodiments. Specific examples of components and arrangements are described below to simplify the present disclosure. These are, of course, merely examples and are not intended to be limiting.

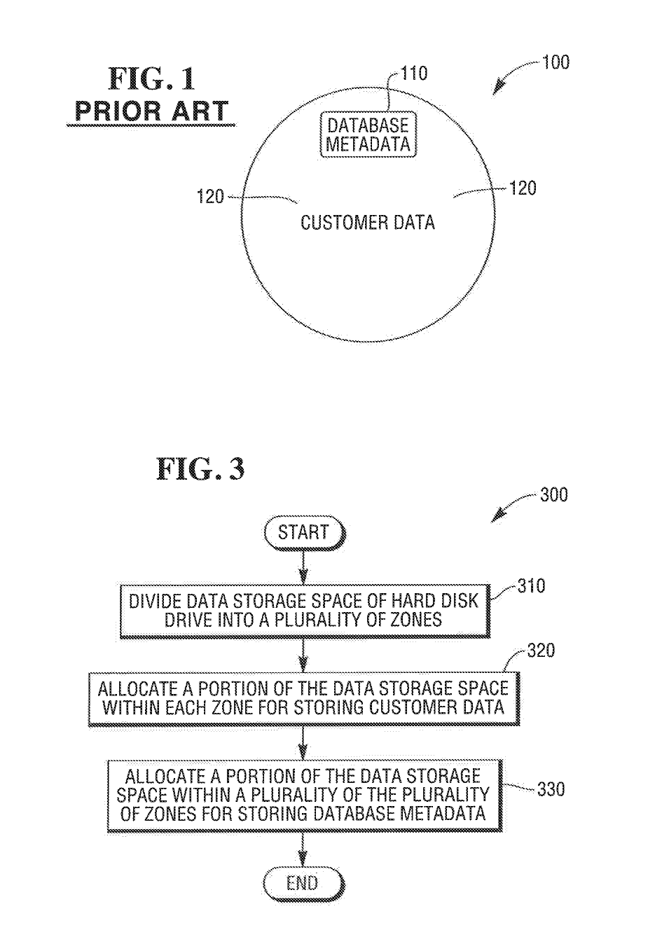

FIG. 1 depicts a diagrammatic representation of a prior art hard disk drive (HDD) 100 allocating database metadata 110 and customer data 120. Database metadata 110 is associated with all of customer data 120 stored on HDD 100. Database metadata 110 may be stored in a “fast region” of HDD 100, which resides on an outer diameter portion of HDD 100. In this case, customer data in all regions of HDD 100 need to access the database metadata 110 in the “fast region” residing on the outer diameter of HDD 100. Seek times in this known data storage space configuration of HDD 100 are relatively small if the associated customer data is also stored in the “fast region” of HDD 100. However, seek times in this known data storage space configuration of HDD 100 are relatively large if the associated customer data is stored in a “slow region” of HDD 100, which resides on an inner diameter portion of HDD 100. Accordingly, HDD 200 operates much slower for customer data that is stored in the “slow region” of HDD 200.

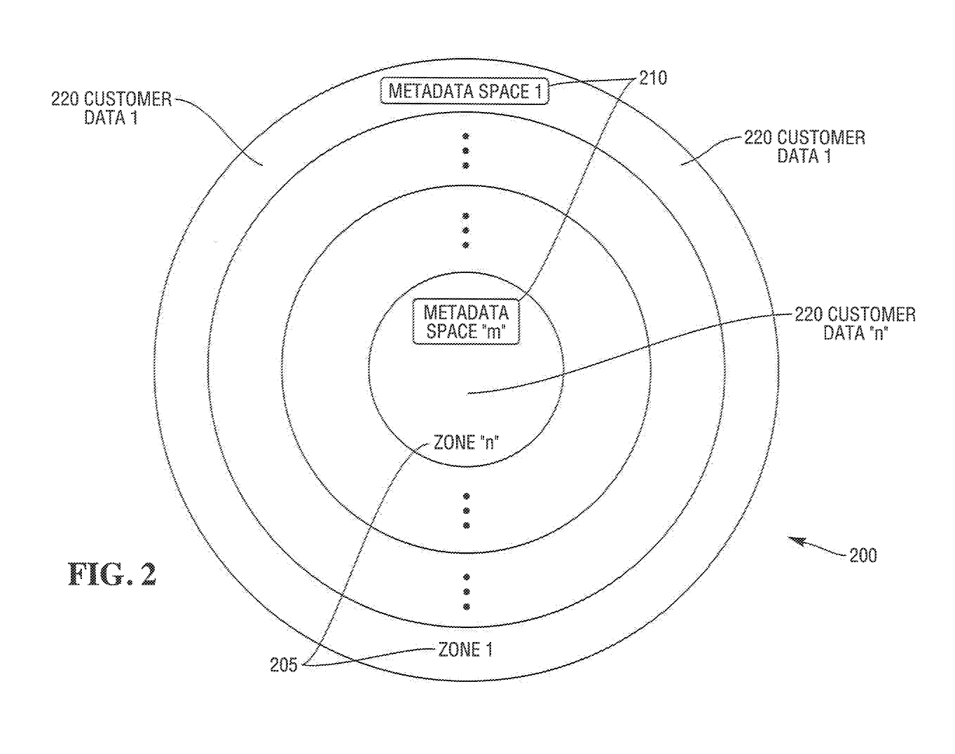

FIG. 2 depicts a diagrammatic representation of a data storage space configuration of HDD 200 constructed in accordance with an embodiment. HDD 200 may include a Teradata Virtual Storage (TVS) architecture, for example, which is available from Teradata Corporation located in Dayton, Ohio. The depicted and described HDD 200 is an example only and is chosen to facilitate an understanding of disclosed embodiments. Other implementations are possible.

As shown in FIG. 2, the data storage space configuration of HDD 200 includes a plurality of zones 205, designated individually from zone 1 to zone “n”, where “n” is the total number of zones. Each one of the plurality of zones 205 stores customer data 220, designated individually from customer data 1 to customer data “n”. The data storage space configuration of HDD 200 also includes a plurality of allocated database metadata spaces 210, designated individually from metadata space 1 to metadata space “m”, where “m” is less than or equal to “n”.

In one implementation, the database metadata comprises temporary metadata, such as transactional metadata for example. Transactional metadata is associated with corresponding customer data for only a limited period of time. Once a transaction is sufficiently committed, the associated metadata for that transaction is deleted, and the HDD data storage space previously used for this metadata is re-purposed for new transactions. Accordingly, the association between transactional metadata and corresponding customer data has a limited lifetime.

In another implementation, the database metadata comprises write-ahead log (WAL) metadata (i.e., WAL-protected metadata updates). In yet another implementation, the database metadata comprises staged-write (DEPOT) metadata.

FIG. 3 is a flowchart 300 that depicts an example method to facilitate configuring data storage space of HDD 200 of FIG. 2 to limit seek distances during database metadata updates in accordance with disclosed embodiments. The processing steps of FIG. 3 may be implemented as computer-executable instructions tangibly embodied on a computer-readable medium executable by a processing system.

As shown in step 310 of FIG. 3, data storage space of HDD 200 is divided into the plurality of zones 205. In step 320, a portion of the data storage space within each of the plurality of zones 205 is allocated for storing customer data 220. In step 330, a portion of the data storage space within a plurality of the plurality of zones 205 is allocated for storing database metadata 210.

The above-described flowchart 300 of FIG. 3, depicts process serialization to facilitate an understanding of disclosed embodiments and is not necessarily indicative of the serialization of the operations being performed. In various embodiments, the processing steps described in the flowchart above may be performed in varying order, and one or more depicted steps may be performed in parallel with other steps. Additionally, execution of some processing steps of the flowchart above may be excluded without departing from embodiments disclosed herein.

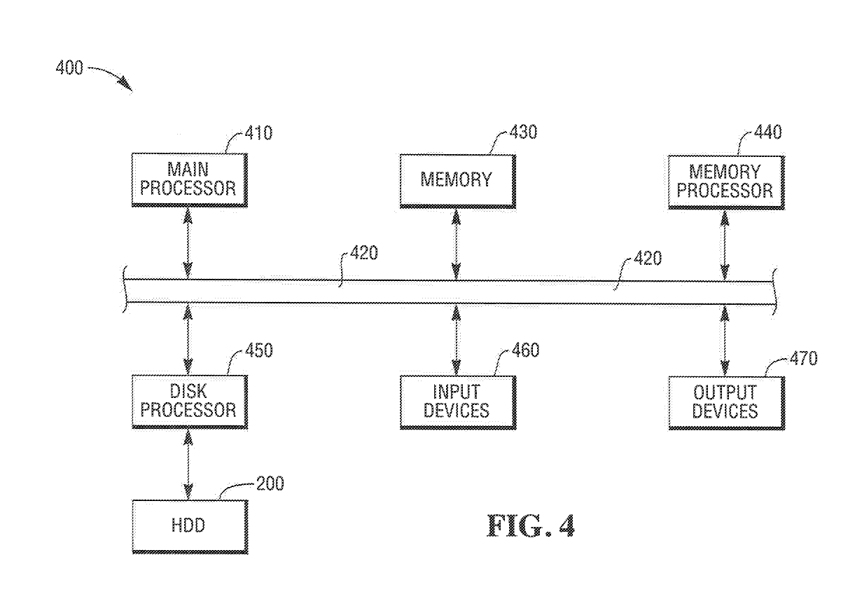

FIG. 4 shows an example computer system 400 suitable for implementation of the method of configuring data storage space of the HDD 200 shown in FIG. 2 in accordance with the flowchart 300 of FIG. 3. The computer system 400 includes a main processor 410 that communicates over a bus 420 with a memory 430, and receives data and program instructions from the memory 430. A memory processor 440 controls flow of data to and from the memory 430. The main processor 410 also communicates over the communications bus 420 through a disk processor 450 with the HDD 200. The computer system 400 further includes a number of input devices 460, such as a keyboard, and a number of output devices 470, such as a display monitor, which allow a human operator to interact with the computer system 400.

It should be apparent that database metadata (e.g., WAL-protected metadata) is periodically set aside in separate zones throughout the addressable range of the entire HDD 200. HDD 200 could be thought of as being logically divided into many equal-size strata or zones. The number of zones is a user-configurable number. Within a zone, a percentage of the data storage capacity in that zone is allocated to storing database metadata, and the rest of the data storage space is allocated conventionally for storing customer data. The percentage of data storage capacity reserved for database metadata may be equal for some or all zones. Also, the percentage of data storage space in a zone may be contiguous within that zone, and may be user-configurable.

Updates to customer data cylinders within a zone results in use of database metadata cylinders within that same zone. In so doing, the seek distance associated with a write to database metadata and customer data is bounded to the distance associated with that particular zone. The greater the number of zones, the smaller each zone becomes, and therefore the shorter the seek distance between the database metadata and the customer data cylinders. For top recovery operations that require a re-read of database metadata, a reasonable cap/limit in the number zones (e.g., 1000 zones) can be enforced to avoid making database metadata reads too random and to avoid potential performance impact.

The above approach ensures that regardless of how mature a database system is (brand new, or nearly full), the seek distance incurred when performing database metadata updates (e.g., WAL-protected metadata updates) is somewhat fixed, and consistent over the life of the database system.

The above HDD solution collocates database metadata and customer data to limit seek distances during database metadata updates. This is accomplished by enabling the customer data in a zone to access corresponding database metadata stored in the same or nearby zone.

The above-described configuration of data storage space for HDD 200 is user-definable and customizable to fit a particular environment. User-defined configurations are externalized to provide a flexible and customizable data storage space solution for a HDD. This is opposite to using a single configuration which is a “one size fits all” type of approach.

The above-described HDD solution can support a number of different scenarios. For example, HDD 200 can support a scenario in which WAL-protected metadata is used. In another example, HDD 200 can support a scenario in which DEPOT metadata is used.

Although the above description describes a TVS architecture supporting HDD 200, it is conceivable that the same concept can be applied to support a wide variety of other types of architectures.

The illustrative diagrams and flowcharts depict process steps or diagrams that may represent modules, segments, or portions of code that include one or more executable instructions for implementing specific logical functions or steps in the process. Although the particular examples illustrate specific process steps or procedures, many alternative implementations are possible and may be made by simple design choice. Some process steps may be executed in different order from the specific description herein based on, for example, considerations of function, purpose, conformance to standard, legacy structure, user interface design, and the like.

Aspects of the disclosed embodiments may be implemented in software, hardware, firmware, or a combination thereof. The various elements, either individually or in combination, may be implemented as a computer program product tangibly embodied in a machine-readable storage device for execution by a processing unit. Various steps of embodiments may be performed by a computer processor executing a program tangibly embodied on a computer-readable medium to perform functions by operating on input and generating output. The computer-readable medium may be, for example, a memory, a transportable medium such as a compact disk, a floppy disk, or a diskette, such that a computer program embodying aspects of the disclosed embodiments can be loaded onto a computer.

The computer program is not limited to any particular embodiment, and may, for example, be implemented in an operating system, application program, foreground or background process, or any combination thereof, executing on a single processor or multiple processors. Additionally, various steps of embodiments may provide one or more data structures generated, produced, received, or otherwise implemented on a computer-readable medium, such as a memory.

Still further, although depicted in a particular manner, a greater or lesser number of modules and connections can be utilized with the present disclosure in order to accomplish embodiments, to provide additional known features to present embodiments, and/or to make disclosed embodiments more efficient. Also, the information sent between various modules can be sent between the modules via at least one of a data network, an Internet Protocol network, a wireless source, and a wired source and via a plurality of protocols. Many other embodiments are also within the scope of the following claims.

What is claimed is:

1. A data storage space configuration of a hard disk drive, the data storage space configuration comprising:
a plurality of zones in which each one of the plurality of zones stores customer data; and
a plurality of database metadata storage spaces allocated in the plurality of zones, wherein the number of database metadata storage spaces is less than or equal to the number of zones.

2. A data storage space configuration of a hard disk drive according to claim 1, wherein the database metadata comprises temporary metadata.

3. A data storage space configuration of a hard disk drive according to claim 1, wherein the database metadata comprises write-ahead log (WAL) metadata.

4. A data storage space configuration of a hard disk drive according to claim 1, wherein the database metadata comprises staged-write (DEPOT) metadata for the purpose of interrupted write recovery.

5. A method of configuring data storage space of a hard disk drive, the method comprising:
electronically by a processor, defining a plurality of zones on the hard disk drive;
electronically by a processor, storing customer data in each one of the plurality of zones; and
electronically by a processor, allocating a plurality of database metadata storage spaces in the plurality of zones, wherein the number of metadata storage spaces is less than or equal to the number of zones.

6. A method according to claim 5, wherein the database metadata comprises temporary metadata.

7. A method according to claim 5, wherein the database metadata comprises write-ahead log (WAL) metadata.

8. A method according to claim 5, wherein the database metadata comprises staged-write (DEPOT) metadata for the purpose of interrupted write recovery.

9. A method according to claim 5, wherein the method is performed by a computer having a memory executing one or more programs of instructions which are tangibly embodied in a program storage medium readable by the computer.

10. A method of collocating customer data and database metadata on a hard disk drive, the method comprising:
dividing data storage space of the hard disk drive into a plurality of zones;
allocating a portion of the data storage space within each zone of the plurality of zone for storing customer data; and
allocating a portion of the data storage space within a plurality of the plurality of zones for storing database metadata.

11. A method according to claim 10, wherein the number of the plurality of the plurality of zones for storing database metadata is less than the number of the plurality of zones.

12. A method according to claim 10, wherein the number of the plurality of the plurality of zones for storing database metadata is equal to the number of the plurality of zones.

13. A method according to claim 10, wherein the database metadata comprises temporary metadata.

14. A method according to claim 10, wherein the database metadata comprises write-ahead log (WAL) metadata.

15. A method according to claim 10, wherein the database metadata comprises staged-write (DEPOT) metadata for the purpose of interrupted write recovery.

16. A method according to claim 10, wherein the method is performed by a computer having a memory executing one or more programs of instructions which are tangibly embodied in a program storage medium readable by the computer.
